(19) United States
(12) Patent Application Publication
(10) Pub. No.: US 2009/0143939 A1
(43) Pub. Date: Jun. 4, 2009

(54) Method and apparatus for maintaining instantaneous center for rotation of load transporter

(76) Inventors: James Rhodes, Las Vegas, CA (US); Kevin T. Parent, Santa Barbara, CA (US); Frank K. Weigand, La Canada, CA (US)

Correspondence Address: K&L Gates LLP, P.O. BOX 1135, CHICAGO, IL, 60690, US

(21) Appl. No.: 11/947,479

(22) Filed: Nov. 29, 2007

(51) Int. Cl. G06F 17/00

(52) U.S. Cl. 701/41; 701/124

(57) ABSTRACT

A vehicle maneuvering system and method are provided. The system includes an input device coupled to a first vehicle and a processor. The processor is configured to determine if the first vehicle is a master vehicle or a slave vehicle to a second vehicle. If the first vehicle is the master vehicle, the processor determines an instantaneous center of rotation based at least partly upon an input received from the input device. If the first vehicle is the slave vehicle, the instantaneous center of rotation is received by the first vehicle. The system also includes a controller configured to position a wheel unit of the first vehicle with the path of the wheel unit being perpendicular to a line passing through the center of the wheel unit and the instantaneous center of rotation.

### RELATED APPLICATIONS

This application is a related to U.S. application Ser. No. 11/431,196, entitled “Building Transport Device”, filed May 9, 2006, U.S. application Ser. No. 11/559,229, entitled “Transport Device Capable of Adjustment to Maintain Load Planarity”, filed Nov. 13, 2006, and U.S. application Ser. No. 11/620,103, entitled “DEVICE AND METHOD FOR TRANSPORTING A LOAD”, filed Jan. 5, 2007, the entire contents of each of which are herein incorporated by reference.

### BACKGROUND

The prior art is generally directed to transporting a load such as a building, house or any other suitable large load by a flat bed delivery device, such as a truck or other device. The prior art delivery devices generally attempt to locate the buildings or houses onto or adjacent to a foundation or other structure prior to the building or house being unloaded from the transporter, to simplify the adjustments necessary to properly position the house upon the foundation.

The house transporters in the prior art are not easily and precisely maneuverable. Further, typical house transportation devices rely upon simple mechanical steering mechanisms in which operating a steering device (such as a steering wheel) merely turns one set of wheels (typically the front wheels of a truck that pulls or pushes the flat bed delivery device). Such turning systems are imprecise and inefficient.

### SUMMARY

In one embodiment, a vehicle maneuvering system includes an input device coupled to a first vehicle and a processor. The processor is configured to determine if the first vehicle is a master vehicle or a slave vehicle to a second vehicle. If the first vehicle is the master vehicle, the processor determines an instantaneous center of rotation based at least partly upon an input received from the input device. If the first vehicle is the slave vehicle, the instantaneous center of rotation is received by the first vehicle. The system also includes a controller configured to position a wheel unit of the first vehicle with the path of the wheel unit being perpendicular to a line passing through the center of the wheel unit and the instantaneous center of rotation.

In one embodiment the system includes a propulsion system configured to rotate a wheel of the wheel unit. In another embodiment, the processor is further configured to transmit the instantaneous center of rotation to the second vehicle if the first vehicle is the master. In still another embodiment, the center of the wheel unit is the center of rotation of a wheel of the wheel unit. In yet another embodiment, the wheel unit includes a plurality of wheels, and the paths of each of the plurality of wheels are parallel.

In one embodiment, the system includes a display device configured to display a representation of the first vehicle. In another embodiment, the display device is configured to display a path of the first vehicle in accordance with proposed maneuvering information entered in a planning mode. In still another embodiment, the path is determined from a plurality of instantaneous centers of rotation. In one embodiment, the display device is configured to display a target location. In another embodiment, the display device is configured to display an obstacle.

In one embodiment, a method of maneuvering a vehicle includes determining if the vehicle is a master vehicle or a slave vehicle to a second vehicle and determining, if the vehicle is the master vehicle, an instantaneous center of rotation based at least partly upon an input received from an input device. The method also includes receiving, if the vehicle is the slave vehicle, the instantaneous center of rotation at the vehicle and positioning a wheel unit of the vehicle with the path of the wheel unit being perpendicular to a line passing through the center of the wheel unit and the instantaneous center of rotation.

In one embodiment, the method includes rotating a wheel of the wheel unit. In another embodiment, the method includes transmitting the instantaneous center of rotation to the second vehicle if the vehicle is the master. In still another embodiment, the center of the wheel unit is the center of rotation of a wheel of the wheel unit. In yet another embodiment, the wheel unit includes a plurality of wheels, and the paths of each of the plurality of wheels are parallel.

In one embodiment, the method includes displaying a representation of the first vehicle. In another embodiment, the method includes displaying a path of the first vehicle in accordance with proposed maneuvering information entered in a planning mode. In one embodiment, the path is determined from a plurality of instantaneous centers of rotation. In another embodiment, the method includes displaying a target location. In still another embodiment, the method includes displaying an obstacle.

Additional features and advantages are described herein, and will be apparent from, the following Detailed Description and the figures.

### BRIEF DESCRIPTION OF THE FIGURES

FIG. 1 is a flow diagram of the process of steering a vehicle in accordance with one embodiment.

FIG. 2 is a block diagram of a composite vehicle traveling in a straight path in accordance with one embodiment.

FIG. 3 is a block diagram of a composite vehicle turning in accordance with one embodiment.

FIG. 4 is a block diagram of a composite vehicle rotating in place in accordance with one embodiment.

FIG. 5 is a block diagram of a composite vehicle traveling in a straight sideways path in accordance with one embodiment.

FIG. 6 is a block diagram of a composite vehicle turning about an instantaneous center of rotation in accordance with one embodiment.

FIG. 7 is a flow diagram of the process of steering a vehicle that can combine with another vehicle in a composite vehicle in accordance with one embodiment.

FIG. 8 is a flow diagram of the process of steering a vehicle by playback of a recorded planning session in accordance with one embodiment.

FIG. 9 is a block diagram of a vehicle turning about a computed instantaneous center of rotation in accordance with one embodiment.

FIG. 10 is a block diagram of a load being nudged into a different position in accordance with one embodiment

### DETAILED DESCRIPTION

In various embodiments, a steering system maneuvers one or more vehicles or composite vehicles by orienting a plurality of wheels perpendicular to an instantaneous center of rotation. In various embodiments, all wheels, wheel units or bogies are independently controllable. In various embodiments, the instantaneous center of rotation can be located at any suitable position, including but not limited to positions between the leading and trailing bogies, wheels or wheel sets and positions within the parameter of the vehicle or vehicles. The one or more vehicles or composite vehicles can be any suitable vehicles, including, but not limited to, those described in U.S. application Ser. No. 11/431,196, entitled “Building Transport Device”, filed May 9, 2006, U.S. application Ser. No. 11/559,229, entitled “Transport Device Capable of Adjustment to Maintain Load Planarity”, filed Nov. 13, 2006, and U.S. application Ser. No. 11/620,103, entitled “DEVICE AND METHOD FOR TRANSPORTING A LOAD”, filed Jan. 5, 2007.

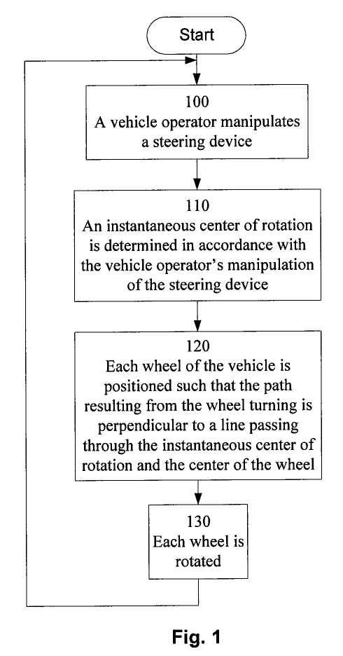

FIG. 1 illustrates the process of steering a vehicle (e.g., a solo or composite vehicle) in accordance with one embodiment. At block 100, a vehicle operator manipulates a steering device. In one embodiment, the steering device is a steering wheel; however, the steering device can be any suitable device, including one or more joysticks, one or more buttons, one or more levers, a touch screen or other computer interface or any combination of two or more steering devices. It should be understood that a vehicle operator can manipulate a steering device by changing the position of the steering device (e.g., turning a steering wheel more or less) or by maintaining the position of a steering device (e.g., holding a steering wheel steady). At block 110, an instantaneous center of rotation is determined in accordance with the vehicle operator's manipulation of the steering device. For example, if the vehicle operator's manipulation indicates that the vehicle should proceed in a straight path, the instantaneous center of rotation is determined to be infinitely distant from one side of the vehicle (typically on a line passing through the center of the vehicle, though the instantaneous center of rotation can be positioned in front of or aft of the center of the vehicle, if desired). Alternatively, if the vehicle operator's manipulation indicates that the vehicle should turn to the right, for example, the instantaneous center of rotation is determined to be a finite distance to the right side of the center of the vehicle. Typically, the instantaneous center of rotation is positioned on a line passing through the center of the vehicle, though the instantaneous center of rotation can be positioned in front of or aft of the center of the vehicle, if desired. If, instead, the vehicle operator's manipulation indicates that the vehicle should turn to the left, the instantaneous center of rotation is determined to be a finite distance to the left side of the vehicle, similar to as described for a right turn.

At block 120, each wheel of the vehicle is positioned such that the path resulting from the wheel turning is perpendicular to a line passing through the instantaneous center of rotation and the center of the wheel (i.e., the wheel's center of rotation). At block 130, each wheel is rotated and the process repeats at block 100. It should be noted that, typically, a wheel located closer to the instantaneous center of rotation rotates less than a wheel located further away if the vehicle is turning. Further, it should be understood that a plurality of wheels may be configured to turn as a unit, and therefore always travel in parallel paths to one another. In such configurations, the plurality of wheels can be positioned such that their path of travel is perpendicular to a line passing through the instantaneous center of rotation and the center of the plurality of wheels.

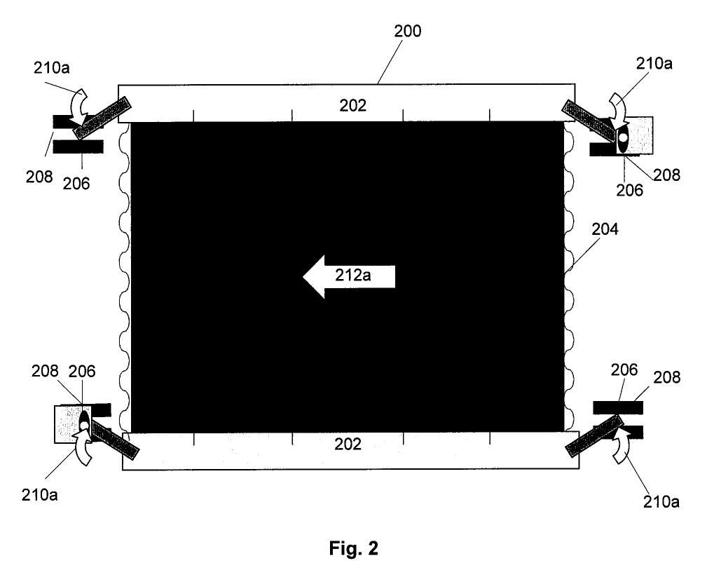

FIG. 2 illustrates a composite vehicle traveling in a straight path in accordance with one embodiment. The composite vehicle 200 includes two separably operable vehicles 202 that have been coupled to act as a single vehicle 200 that transports a large load such as a house 204 or other suitable building structure or any other suitable large load. Each vehicle 202 includes two bogies 206, each of which has two wheels 208, though it should be understood that in other embodiments, the vehicles can have any suitable number of bogies and bogies can have any suitable number of wheels. The bogies 206 are positioned to the interior of composite vehicle. It should be noted that the bogies 206 can be individually repositioned without moving the rest of the composite vehicle 200 or the house being transported by rotating an individual bogie 206 about an instantaneous center of rotation positioned at the point at which the bogie 206 is pivotally connected to the composite vehicle 200. As a result, the bogies 206 can individually be moved as indicated by arrow 210a.

In FIG. 2, the composite vehicle 200 is traveling in the direction indicated by arrow 212a. Further, the instantaneous center of rotation is positioned infinitely far from the composite vehicle 200 on the left side of the composite vehicle 200. It should be noted, the instantaneous center of rotation could be positioned infinitely far to the right of the composite vehicle 200 and the resulting path traveled would be the same. Because the instantaneous center of rotation is infinitely far to a side, a line passing through the instantaneous center of rotation and any of the centers of the bogies 206 is perpendicular to arrow 212a. As a result, each of the wheels 208 is positioned to be parallel with arrow 212a, and the composite vehicle 200 travels in a straight path.

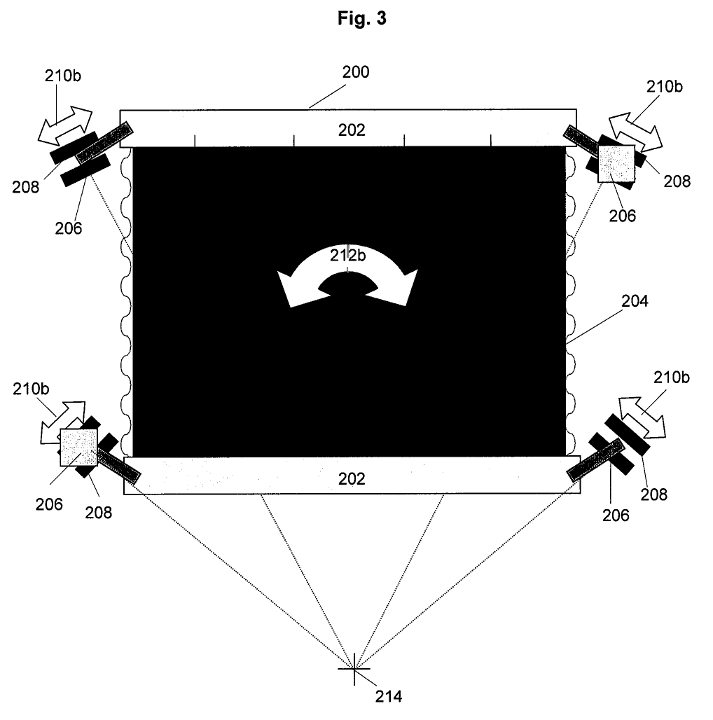

FIG. 3 illustrates a composite vehicle turning in accordance with one embodiment. In FIG. 3, the composite vehicle 200 is turning in either of the directions indicated by arrow 212b. The instantaneous center of rotation 214 is positioned on the left side of the composite vehicle 200. Further, a line that is perpendicular to the composite vehicle's 200 forward to rear axis passes through the center of the composite vehicle 200. For each bogie 206, the wheels 208 are rotated such that the path traveled by the wheels as indicated by arrows 210b are perpendicular to a line from the instantaneous center of rotation to the center of the bogie 206. As a result, when the wheels 208 are rotated, the composite vehicle 200 turns.

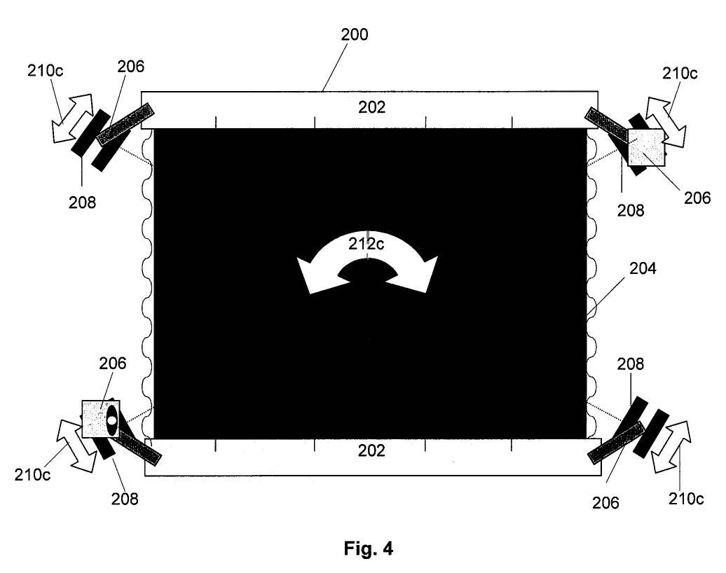

It should be noted that turning the composite vehicle based on an instantaneous center of rotation provides an efficient mechanism for maneuvering the composite vehicle in many different ways. For example, FIG. 4 illustrates a composite vehicle rotating in place in accordance with one embodiment. In FIG. 4, the composite vehicle 200 is rotating in either of the directions indicated by arrow 212c. The instantaneous center of rotation 214 is positioned at the center of the composite vehicle 200. For each bogie 206, the wheels 208 are rotated such that the path traveled by the wheels as indicated by arrows 210c are perpendicular to a line from the instantaneous center of rotation to the center of the bogie 206. As a result, when the wheels 208 are rotated, the composite vehicle 200 rotates about its center.

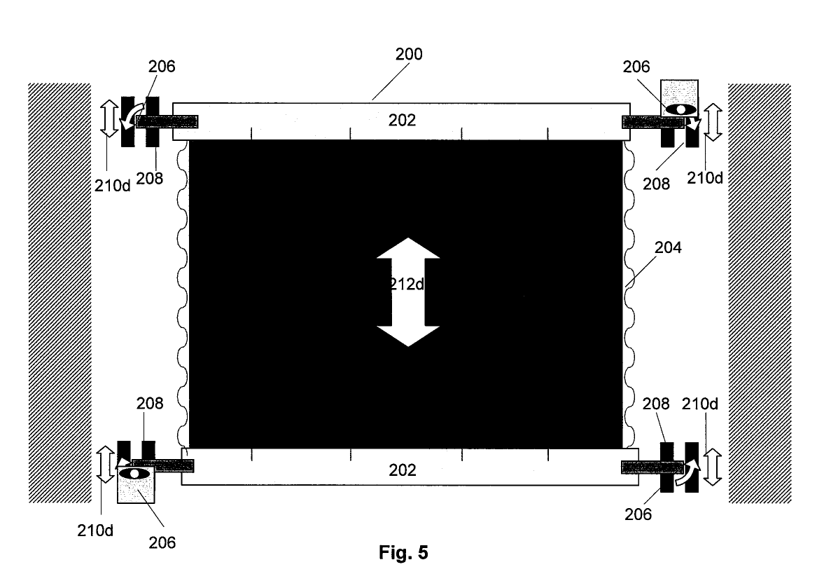

FIG. 5 illustrates a composite vehicle traveling in a straight sideways path in accordance with one embodiment. In FIG. 5, the composite vehicle 200 is traveling in either of the directions indicated by arrow 212d. The instantaneous center of rotation is positioned infinitely far from the composite vehicle 200 to the rear of the composite vehicle 200. It should be noted, the instantaneous center of rotation could be positioned infinitely far to the front of the composite vehicle 200 and the resulting path traveled would be the same. Because the instantaneous center of rotation is infinitely far to the rear, a line passing through the instantaneous center of rotation and any of the centers of the bogies 206 is perpendicular to arrow 212d. As a result, each of the wheels 208 is positioned to be parallel with arrow 212d, and the composite vehicle 200 travels in a straight path sideways.

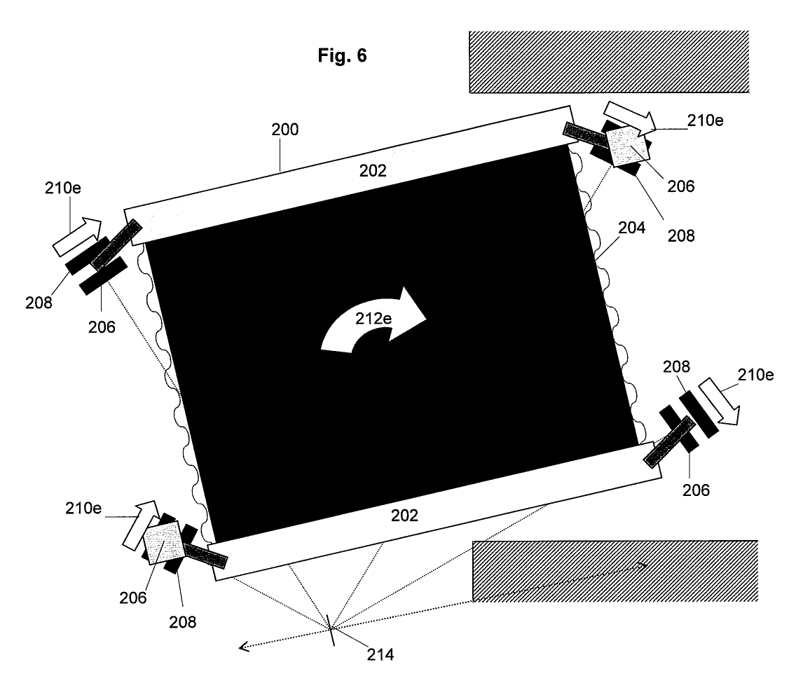

It should be noted, that the instantaneous center of rotation can be located in suitable any position. For example, the instantaneous center of rotation can be to the side of a vehicle and in front of, behind or on the left/right central axis. Similarly, the center of rotation can be in front of or behind the vehicle and to the left of, to the right of or on the front/back central axis. For example, FIG. 6 illustrates a composite vehicle turning about an instantaneous center of rotation in accordance with one embodiment. In FIG. 6, the composite vehicle 200 is turning in the direction indicated by arrow 212e. The instantaneous center of rotation 214 is positioned on the right side of the composite vehicle 200. Further, the instantaneous center of rotation 214 is located to the rear of a line that is perpendicular to the composite vehicle's 200 forward to rear axis that passes through the center of the composite vehicle 200. For each bogie 206, the wheels 208 are rotated such that the path traveled by the wheels as indicated by arrows 210e are perpendicular to a line from the instantaneous center of rotation to the center of the bogie 206. As a result, when the wheels 208 are rotated, the composite vehicle 200 turns. In one embodiment, an operator is provided with a plurality of selectable fore-aft or right-left steer axis (e.g., front, front-mid, mid, rear-mid, rear, etc.). In another embodiment, the operator can cause the instantaneous center of rotation to be at any suitable point.

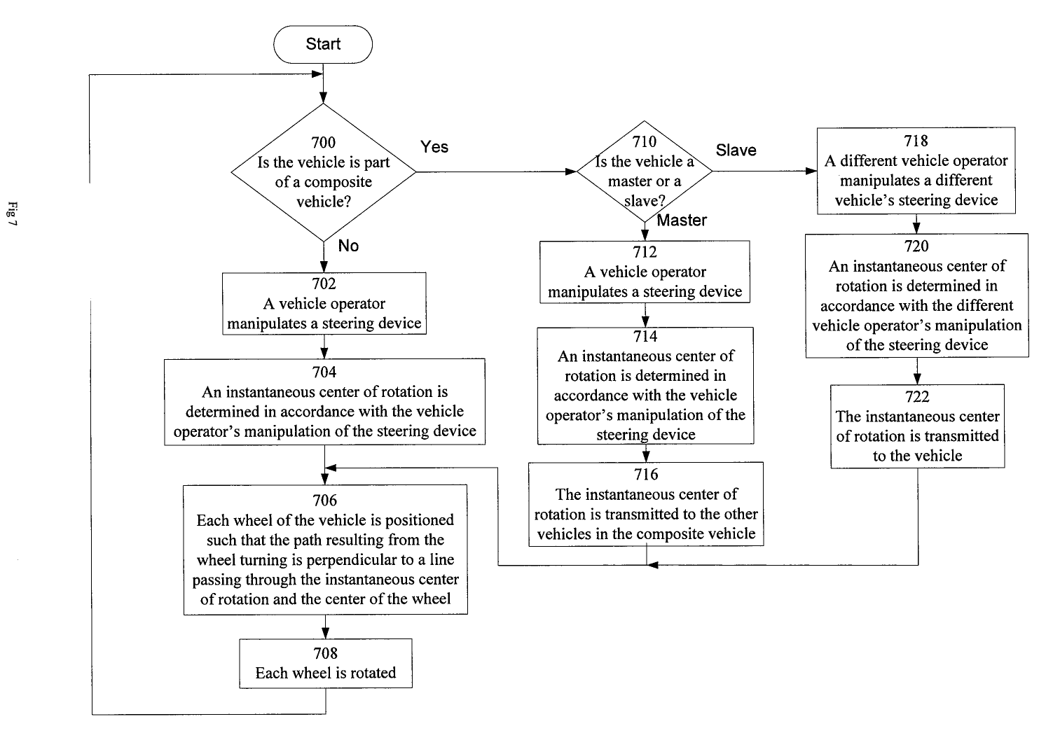

FIG. 7 illustrates the process of steering a vehicle that can combine with another vehicle in a composite vehicle in accordance with one embodiment. At block 700, it is determined whether the vehicle is part of a composite vehicle. If the vehicle is not part of a composite vehicle, at block 702, a vehicle operator manipulates a steering device. At block 704, an instantaneous center of rotation is determined in accordance with the vehicle operator's manipulation of the steering device. At block 706, each wheel of the vehicle is positioned such that the path resulting from the wheel turning is perpendicular to a line passing through the instantaneous center of rotation and the center of the wheel. At block 708, each wheel is rotated and the process repeats at block 700.

If the vehicle is part of a composite vehicle (e.g., the vehicle is attached to another vehicle to form a composite vehicle or a vehicle already was and continues to be part of a composite vehicle), at block 710, it is determined whether the vehicle is a master or a slave. If the vehicle is a master, at block 712, a vehicle operator manipulates a steering device. At block 714, an instantaneous center of rotation is determined in accordance with the vehicle operator's manipulation of the steering device. At block 716, the instantaneous center of rotation is transmitted to the other vehicles in the composite vehicle at the process continues at block 706.

If the vehicle is a slave, at block 718, a different vehicle operator manipulates a different vehicle's steering device. At block 720, an instantaneous center of rotation is determined in accordance with the different vehicle operator's manipulation of the steering device. At block 722, the instantaneous center of rotation is transmitted to the vehicle and the process continues at block 706. It should be noted that rather than transmitting the instantaneous center of rotation, a master vehicle can directly control the position of wheels in other vehicles in the composite vehicle, transmit an orientation for each wheel in other vehicles or effect the master's commands in any other suitable manner.

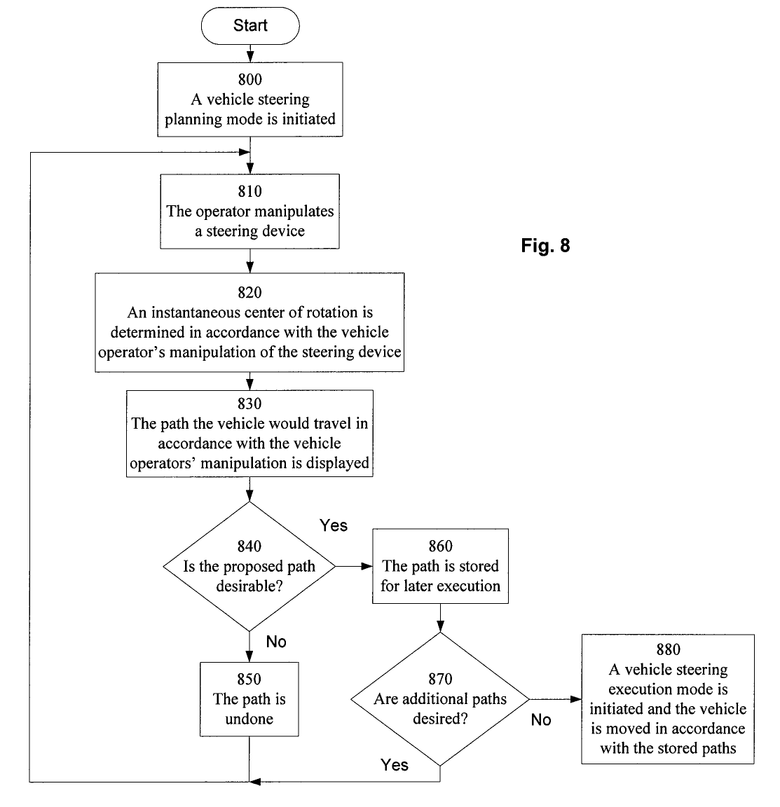

FIG. 8 illustrates the process of steering a vehicle by playback of a recorded planning session in accordance with one embodiment. At block 800, a vehicle steering planning mode is initiated. At block 810, the operator manipulates a steering device. At block 820, an instantaneous center of rotation is determined in accordance with the vehicle operator's manipulation of the steering device. At block 830, the path the vehicle would travel in accordance with the vehicle operators' manipulation is displayed. At block 840, it is determined whether the proposed path is desirable. If the proposed path is not desirable, at block 850, the path is undone and the process repeats at block 810. If the path is desirable, at block 860, the path is stored for later execution. At block 870, it is determined whether additional paths are desired. If additional paths are desired, the process repeats at block 810. If additional paths are not desired, at block 880, a vehicle steering execution mode is initiated and the vehicle is moved in accordance with the stored paths.

In one embodiment, an image representing the vehicle (e.g., a solitary vehicle or a composite vehicle) is displayed to the operator. Preferably, the image is an overhead representation; however the image can be any suitable representation. Further, the display preferably also shows representations of the vehicle's environment; however such representations are not required. The representation of the vehicle's environment can include a target end position and/or obstacles. The representations can be provided by a camera (e.g., a camera elevated substantially above the vehicle (e.g., on a pole or other structure of a vehicle or on a helicopter, satellite or other separate vehicle. Further, the representations can be live feed or historical images. Further still, the representation can be created from one or more position sensors (e.g., GPS sensors). Such sensors can be placed on the vehicle (e.g., at the center or at each corner) and/or on any suitable locations associated with a target position and/or obstacles (e.g., one or more corners of a target location for a house, one or more edges or corners of a house, tree, pole or other obstacle). The sensors can transmit absolute or relative position data to the vehicle or any other suitable device which generates the representation to be displayed.

In one embodiment, the instantaneous center of rotation is also displayed to the operator, if it fits in the display area. In another embodiment, the position of the vehicle that will result due to the operator's steering manipulations is displayed without actually causing the vehicle to move. As a result, the operator can experiment with paths that safely and efficiently position the house at the target location. Preferably, these paths can be recorded and used to cause the vehicle to move; however, recording of the paths is not required and/or the operator can be required to attempt to manually recreate the paths to actually move the vehicle, if desired. In one embodiment, a processing unit calculates a recommended path using one or more sequential instantaneous centers of rotation. If the operator approves the path, the vehicle can be automatically moved through that path under the operator's supervision.

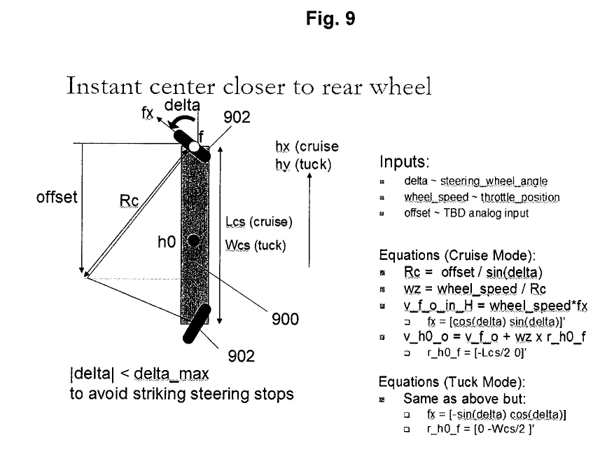

FIG. 9 illustrates a vehicle turning about a computed instantaneous center of rotation in accordance with one embodiment. To minimize stresses on the vehicle 900 and payload, algorithms are used to ensure the bogies 902 steer in a kinematically consistent manner to avoid “fighting” one another. One algorithm, called “countersteering”, transforms operator inputs from any two devices (e.g., steering wheel, throttle, joysticks, etc.) into three vehicle overall commands: longitudinal speed of a reference point on the vehicle, lateral speed of the same reference point on the vehicle, and vehicle yaw rate. The countersteering algorithm transforms the two operator inputs into three overall commands using an “instant center” calculation. The instant center may be on a line passing through the rear bogies (front wheel steer), on a line passing laterally through the midpoint of the vehicle (“four wheel steering”) or, more generally, on a lateral line located anywhere fore or aft of the center of the vehicle or any other suitable line.

Alternate schemes for transforming operator inputs into three vehicle overall commands include “pirouette” and “hook and ladder”. In “pirouette”, the algorithm utilizes one command input from the operator, yaw rate, and transforms it into a rotation about an arbitrary fixed point. In “hook and ladder”, the algorithm utilizes three operator inputs (e.g., front steering wheel, rear steering wheel, and throttle) to produce the three vehicle overall commands.

In this embodiment, whether produced from countersteer, pirouette, or hook-and-ladder, the algorithm maps the three vehicle overall commands (e.g., longitudinal speed, lateral speed, and yaw rate) into wheel speed commands for each individual wheel. The algorithm does this by computing the desired bogie heading, with respect to the vehicle and desired speeds for the center of each bogie. Each bogie adjusts its heading to match its commanded heading through differential steering. Each bogie adjusts its center's speed to match the command speed by adjusting the mean of the wheel speeds for each bogie. Note that, in various general cases, each bogie has a different command speed and heading. However in various special cases, such as when the vehicle is traveling in a straight line, the command speeds and headings for all bogies are identical.

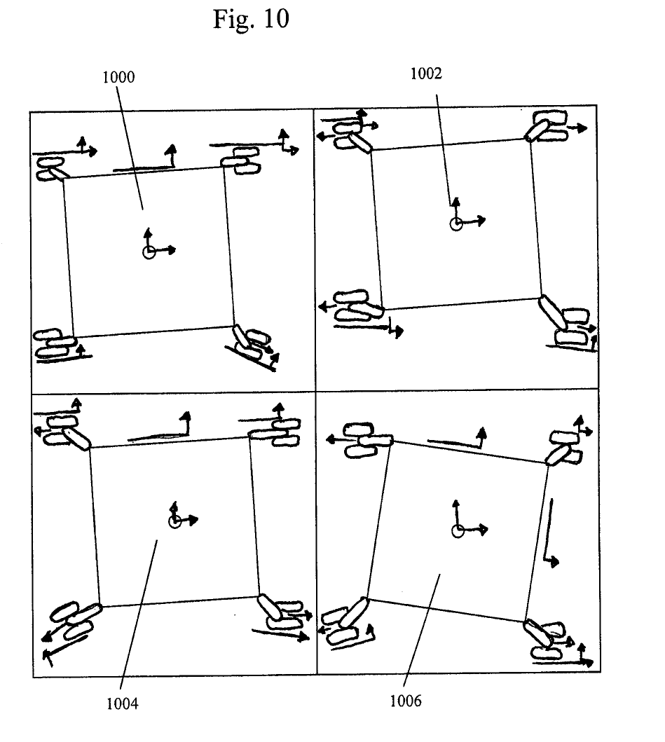

FIG. 10 illustrates another mode of operation, called “Nudge,” in accordance with one embodiment. Specifically, a load is nudged from position 1000 to position 1002. Similarly, a load is nudged from position 1004 to position 1006. Nudge is used for fine positioning of the vehicle over a limited range of motion in various embodiments. Nudge uses the additional degrees of freedom provided by the slewing yokes to move the vehicle without steering the bogies. Steering the bogies, for fine positioning, can be problematic because it can involve the bogies steering in place repeatedly, which could cause disruption of the road surface. The Nudge algorithm transforms three operator inputs, coming from any devices (e.g., three-axis joystick) into three vehicle overall commands: longitudinal speed, lateral speed, and yaw rate. These three overall commands are transformed into individual wheel speed commands and yoke slew rate commands. However, unlike the differential steering approach described in the previous paragraphs, the individual wheel speeds for a given bogie are identical. The degrees of freedom provided by differential steering are replaced by the degrees of freedom from slewing the yokes.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A vehicle maneuvering system comprising:
an input device coupled to a first vehicle,
a processor configured to determine if the first vehicle is a master vehicle or a slave vehicle to a second vehicle, wherein the first vehicle and the second vehicle cooperate to transport a load, wherein, if the first vehicle is the master vehicle, the processor determines an instantaneous center of rotation based at least partly upon an input received from the input device, and wherein, if the first vehicle is the slave vehicle, the instantaneous center of rotation is received by the first vehicle; and
a controller configured to position a wheel unit of the first vehicle with the path of the wheel unit being perpendicular to a line passing through the center of the wheel unit and the instantaneous center of rotation.

2. The vehicle maneuvering system of claim 1, further comprising:
a propulsion system configured to rotate a wheel of the wheel unit.

3. The vehicle maneuvering system of claim 1, wherein the processor is further configured to transmit the instantaneous center of rotation to the second vehicle if the first vehicle is the master.

4. The vehicle maneuvering system of claim 1, wherein the load is a building.

5. The vehicle maneuvering system of claim 1, wherein the wheel unit includes a plurality of wheels, wherein the paths of each of the plurality of wheels are parallel.

6. The vehicle maneuvering system of claim 1, further comprising:
a display device configured to display a representation of the first vehicle.

7. The vehicle maneuvering system of claim 6, wherein the display device is configured to display a path of the first vehicle in accordance with proposed maneuvering information entered in a planning mode.

8. The vehicle maneuvering system of claim 7, wherein the path is determined from a plurality of instantaneous centers of rotation.

9. The vehicle maneuvering system of claim 8, wherein the display device is configured to display a target location.

10. The vehicle maneuvering system of claim 8, wherein the display device is configured to display an obstacle.

11. A method of maneuvering a vehicle comprising:
determining if the vehicle is a master vehicle or a slave vehicle to a second vehicle, wherein the first vehicle and the second vehicle cooperate to transport a load;
determining, if the vehicle is the master vehicle, an instantaneous center of rotation based at least partly upon an input received from an input device;
receiving, if the vehicle is the slave vehicle, the instantaneous center of rotation at the vehicle; and
positioning a wheel unit of the vehicle with the path of the wheel unit being perpendicular to a line passing through the center of the wheel unit and the instantaneous center of rotation.

12. The method of claim 11, further comprising:
rotating a wheel of the wheel unit.

13. The method of claim 11, further comprising:
transmitting the instantaneous center of rotation to the second vehicle if the vehicle is the master.

14. The method of claim 11, wherein load is a building.

15. The method of claim 11, wherein the wheel unit includes a plurality of wheels, wherein the paths of each of the plurality of wheels are parallel.

16. The method of claim 11, further comprising:
displaying a representation of the first vehicle.

17. The method of claim 16, further comprising:
displaying a path of the first vehicle in accordance with proposed maneuvering information entered in a planning mode.

18. The method of claim 17, wherein the path is determined from a plurality of instantaneous centers of rotation.

19. The method of claim 18, further comprising:
displaying a target location.

20. The method of claim 18, further comprising:
displaying an obstacle.
